(19) United States
(12) Patent Application Publication
(10) Pub. No.: US 2009/0138200 A1
(43) Pub. Date: May 28, 2009

(54) Portable Navigation System

(76) Inventors: Andrew Hunter, Calgary (CA); Naser El-Sheimy, Calgary (CA); Zainab Syed, Calgary (CA); David Bruce Wright, Calgary (CA)

Correspondence Address: Nixon Peabody LLP, 200 Page Mill Road, Palo Alto, CA, 94306, US

(21) Appl. No.: 12/168,744

(22) Filed: Jul. 7, 2008

Related U.S. Application Data
(60) Provisional application No. 60/958,626, filed on Jul. 5, 2007.

(51) Int. Cl. G01C 21/00

(52) U.S. Cl. 701/216

(57) ABSTRACT

An apparatus and method for providing personal navigation and location information is disclosed. For one embodiment, a personal navigation system includes a navigation module to receive and determine personal navigation and location information and a display communicatively coupled to the sensor for displaying the personal navigation and location information to a user. The display is detachably joined to the sensor allowing the display to be detached from the sensor and moved such that movement of the display does not impair the determination of the personal navigation and location information.

### CROSS REFERENCE TO RELATED APPLICATIONS

This application claims benefit of the U.S. Provisional Application Ser. No. 60/958,626, filed on Jul. 5, 2007, which is incorporated by referenced herein.

### TECHNICAL FIELD

The present disclosure relates generally to navigation systems and, more specifically, to personal navigation systems integrating dead reckoning positioning sensors and systems.

### BACKGROUND

Conventional navigation systems for vehicle navigation typically employ a satellite-based positioning system, for example, a Global Navigation Satellite System (GNSS) such as the Global Positioning System (GPS). Such systems typically include a GPS receiver to estimate position and a digital map display to display the position and other information to the user. A disadvantage of such systems is that the satellite signal used to estimate the position of the vehicle may not be received in various circumstances (e.g., if the vehicle enters a tunnel, a forest, or an urban canyon). Personal (e.g., handheld) navigation and positioning systems (PNS) that are satellite-based also suffer from this disadvantage.

To address this problem, some navigation systems integrate dead reckoning (DR) capabilities with satellite-based positioning systems in order to provide positioning information when satellite reception is impaired or unavailable. The DR systems typically include a plurality of inertial measurement sensors, such as gyroscopes and accelerometers, which provide short-range navigation information. These DR systems however have several distinct disadvantages in that they cannot be used for vehicle navigation as they are required to be fixed to the body of the user, and, over time there is substantial performance degradation when used in a GPS-denied environment.

Such systems were developed primarily to allow users external to the navigation system to track the person wearing the system. For personal navigation (e.g., situations in which a user wants to know where they are and the direction and distance to travel to reach a desired location), it is useful for the personal navigation system to include a display that is easy to view.

Conventional systems require that a user remove the personal navigation system from their body in order to accurately and conveniently view the display. Such movement of the system detrimentally affects the accuracy of the DR position information provided by the system. For example, a dead reckoning based step detection system cannot accurately identify a user's steps or the true heading of the user as the PNS is no longer fixed in the user's body frame (e.g., position and orientation). Inertial based PNSs may continue to function under such circumstances, but the error due to movement of the system is time dependent and performance typically degrades to an unacceptable level in a relatively short time. Additionally, the PNS may continue to be moved by the user resulting in an erroneous determination of user position by the PNS.

### OVERVIEW

Disclosed a personal navigation and positioning systems (PNS) which provides a continuous navigation solution for pedestrian or vehicular motion with or without satellite-based positioning. In one example embodiment, the PNS includes a navigation module to receive and determine personal navigation and location information and a display communicatively coupled to navigation module for displaying the personal navigation and location information to a user. The display may be physically separated from, or detachably joined to, the navigation module allowing the display to be moved such that movement of the display does not impair the determination of the personal navigation and location information.

Other advantages and embodiments will be described in the detailed description.

### BRIEF DESCRIPTION OF THE DRAWINGS

The invention may be best understood by referring to the following description and accompanying drawings that are used to illustrate embodiments of the invention.

In the drawings:

FIG. 1 illustrates a diagram of the PNS in accordance with one example embodiment;

FIG. 2 illustrates a diagram of the PNS in accordance with another example embodiment;

FIG. 3 illustrates several example coupling configurations for the PNS;

FIG. 4 illustrates a flow diagram of one example embodiment of operation of the PNS,

FIG. 5 illustrates a diagram of one example embodiment of digital processing system.

### DETAILED DESCRIPTION OF EXAMPLE EMBODIMENTS

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice the present invention. In other instances, well-known computing systems, electric circuits and various data collection devices are shown in block diagram form to avoid obscuring the present invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

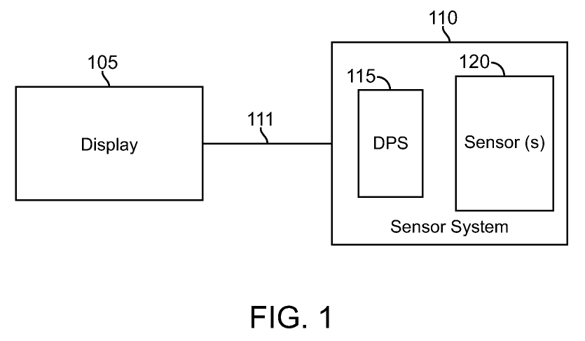

FIG. 1 illustrates one example embodiment of a Personal Navigation and Positioning System (PNS). PNS 100 includes a display module 105, which includes a display screen to, a communication link 11111 to communicate with the navigation module 110 and a power supply (not shown). The display module 105 may be used to display digital maps, position and location information and other types of video, audio, graphics, text, multi-media and other types of data. In one example embodiment, the display 105 may be a touch screen display. In one example embodiment, the navigation module 110 may include a digital processing system (DPS) 115 and a plurality of sensors 120 for determining personal navigation and location information. Several example embodiments of the navigation module 110 will be described in a greater detail herein.

In one example embodiment, the communication link 111 may be wired, such as a. Universal Serial Bus (USB), a FireWire interface or other type of serial or parallel data communication interface known to those of ordinary skill in the art. In another example embodiment, the communication link may be wireless, such as WiFi or Bluetooth communication link, or other type of RF or optical communication interface know to those of skill in the art. Wireless connectivity allows the display 105 to be moved without moving the navigation module 110. Such configuration allows a user to view the display 105 without impairing the accuracy of the navigation and location information determined by the various sensors of the navigation module 110. Yet in another example embodiment, the communication link 111 may include both wired and wireless data transmission capabilities.

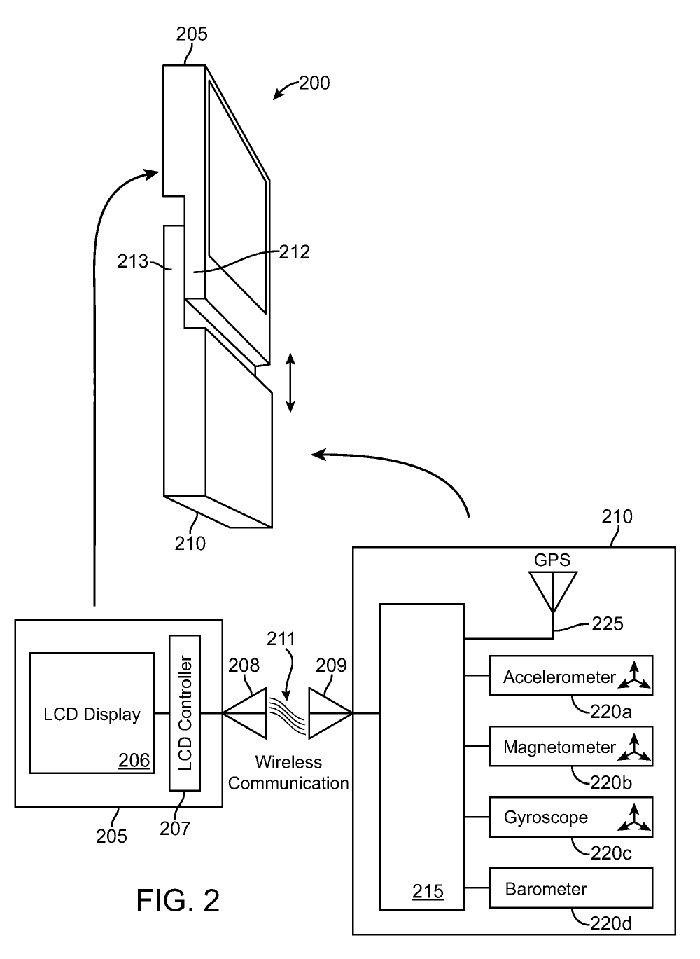

FIG. 2 illustrates a functional block diagram of a PNS integrating a satellite-based positioning system and a dead reckoning (DR) positioning system in accordance with one example embodiment. PNS 200 includes a display 205, which, as shown, includes an LCD display 206, an LCD controller 207, and wireless communication interface 208. The display 205 is communicatively coupled via a wireless communication link 211 to a navigation module 210. The module 210 includes a DPS 215, which may, for example, include a processor and memory, a plurality of DR sensors 220, such as sensors 220a-220d, and a wireless communication interface 208. Navigation module 210 also includes satellite-based navigation interface, such as Global Navigation Satellite System (GNSS) 225 or other know type of satellite signal receiver.

In one example embodiment, the DR sensors 200 may include one or more accelerometers, such as tri-axial accelerometer 220a, one or more magnetometers, such as tri-axial magnetometer 220b, one or more gyroscopes, such as three orthogonal gyros 220c and a barometer 220d. In alternative embodiments, the DR sensors 220 may include any combination of these measurement devices and/or other measurement devices for effecting DR positioning.

In one example embodiment, the display 205 and the navigation module 210 may be configured to be physically coupled at sections 212 and 213 respectively via a wired communication interface (not shown), such as a USB or FireWire interface. As shown, the display 205 may be detachably coupled to the navigation module 210 via a wireless communication interface 211 described above. The detachable physical coupling allows a user to detach and view the display 205 without impairing the accuracy of the navigation and location information determined by the various inertial sensors housed in the navigation module 210.

In some embodiments, it may be desired that the navigation module 210 remain fixed to the moving body of the user. Such embodiments may include an additional component to fix the navigation module 210, such as belt clip, neck chain, carrying case/pouch, Velcro strips or other fastening and carrying means. Various embodiments will include various mounting configurations and various combinations of components.

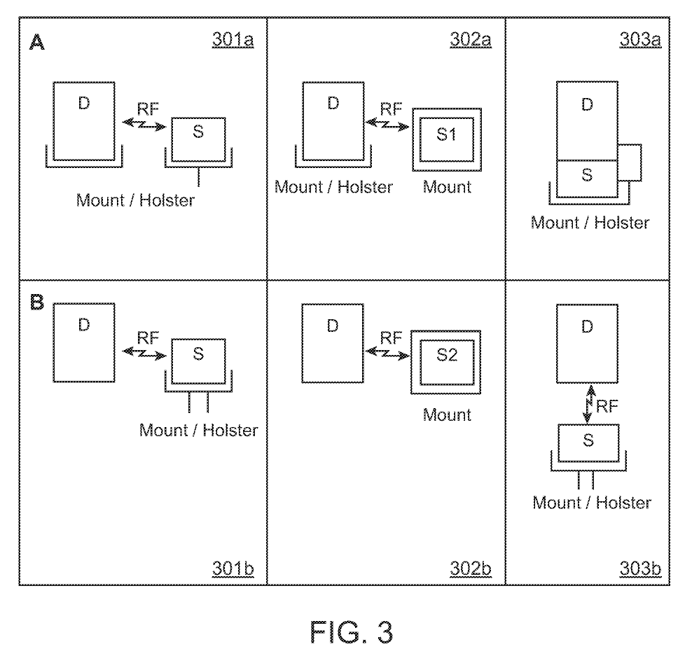

As will be appreciated there are many alternative embodiments for detachably coupling the display and the sensor in accordance with various embodiments. FIG. 3 illustrates coupling configurations for detachably coupling a PNS in accordance with various alternative embodiments. As shown, PNS configurations 301a, 302a and 303a have the display device mounted as it may be, for example, in a vehicle. PNS configurations 301b, 302b and 303b have only the sensor being mounted which may be used in either a vehicle mode or a pedestrian mode. PNS configurations 302a and 302b indicate permanently mounted navigation modules, either inside the vehicle or on the pedestrian, with or with out a mount for the display unit.

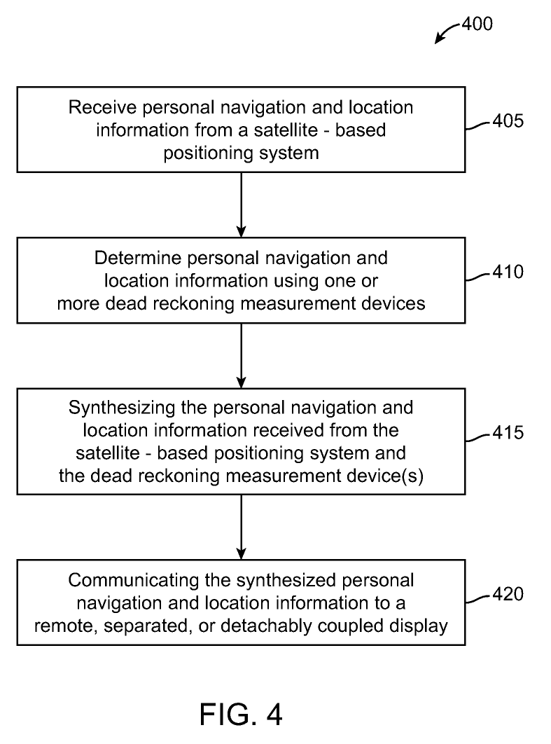

FIG. 4 illustrates a process for presenting personal position and location information to a user in accordance with one example embodiment. Process 400 begins at operation 405 in which personal navigation and location information is received from a satellite-based positioning system, such as Global Navigation Satellite System (GNSS). The satellite provided navigation data may include but is not limited, position, velocity, pseudo range and Doppler measurements.

At operation 410, personal navigation and location information is determined by one or more DR sensors, such as gyroscopes, accelerometers, magnetometers and others measuring devices. The DR data may include but is not limited to inertial measurement data, such as linear motion in forward, backward, sideways and vertical directions, as well as roll, pitch and azimuth measurements. Other types of navigation data know to those skilled in the art may be collected.

At operation 415, the personal navigation and location information received from a satellite-based positioning system and the inertial measurement data determined by one or more DR measurement devices is processed to create a synthesized personal navigation and location information. The processing algorithm may include Kalman-based filters, Particle filters or other data processing algorithms known to those of skill in the art.

At operation 420, the synthesized personal navigation and location information is communicated to a display via a communication link. The display may be remote from, separate from, or detachably coupled to the satellite-based positioning system receiver and the DR measurement devices. Use or movement of the display does not substantially impair the accuracy of the personal navigation and location information received from a satellite-based positioning system, the personal navigation and location information determined by one or more DR measurement devices, or the synthesized personal navigation and location information.

In one example embodiment, the PNS may include a locomotion mode detection mechanism to determine whether the PNS is attached to a vehicle (e.g., an automobile) or to the person (body) of a user, for example attached to the user's belt. The detection mechanism may be implemented in hardware or software and may be electrical, mechanical or wireless. In various embodiments, the detection mechanism may be automatic or user activated. The detection of the mode of user motion allows the processing of the sensor data to be effected using the mode-appropriate algorithms, as will be described in a greater detail herein below.

In one example embodiment, the PNS may perform mode switching between the car navigation mode and the personal navigation mode according to whether the display module is physically coupled through the wired/wireless communication interface to the navigation module. For example, when the display module is build into the car dashboard, the PNS will determine that system is used in driving conditions. In another example embodiment, the PNS may perform mode switching according to GNSS velocity measurements. For example, when the GNSS-provided velocity measurement is below a certain threshold, such as 6 miles/hour (i.e. average walking speed), the PNS may conclude that it is used in personal/pedestrian mode. Yet in another example embodiment, the PNS may perform mode switching according to the DR sensor readings. For example, the accelerometer-generated frequency waveforms may be used to distinguish walking and driving motions using methods know to those skilled in the art. Yet in another example embodiment, the user may be prompted to manually select driving or personal locomotion mode. Other mode switching techniques may be used in alternative embodiments.

Since motion dynamics during driving and walking are typically different, in accordance with one example embodiment, the PNS may use different data processing algorithms to synthesize personal navigation and location information from the satellite-based positioning data and the inertial measurement data depending on the detected mode of locomotion. In the personal/pedestrian mode, where motion dynamics are relatively low, the PNS may for example implement a Kalman Filter algorithm, such as Extended Kalman Filter and Unscented Kalman Filter. In the driving mode, where motion dynamics are higher, the PNS may for example implement a Particle Filter algorithm, such as a SIS Particle Filter, SIR Particle Filter, Extended Particle Filter and Unscented Particle Filter. In addition) in the driving mode, the PNM may apply non-holonomic constraints to data processing. Non-holonomic constraints use the fact that a land vehicle cannot move sideways or vertically and hence the velocity components associates with these directions may be neglected during data processing. Those of skill in the art will appreciate that various combination of these algorithms as well as other data processing techniques may be use in alternative embodiments of the invention.

Yet in another example embodiment, the PNS may select, depending on the mode of locomotion, one or more sources of navigation data to be used to determine personal navigation and location information for the user. For example, in the driving mode, the PNS may rely more, or primarily, on the satellite navigation data due to the high speed of the user motion. While in the personal/pedestrian mode, the PNS may rely more on the measurements of the DR sensors. Furthermore, the PNS may use fewer or more DR sensors to determine user position depending on the user mode of locomotion. Thus, for example, in one mode, the PNS may only rely on the measurements of one gyroscope and one accelerometer, and, in another mode, it may use measurements of three orthogonal gyros and three orthogonal accelerometers. In addition, the PNS may use various data processing techniques, such as Backward Smoothing or other known techniques, to further improve quality of navigation data in various operational modes.

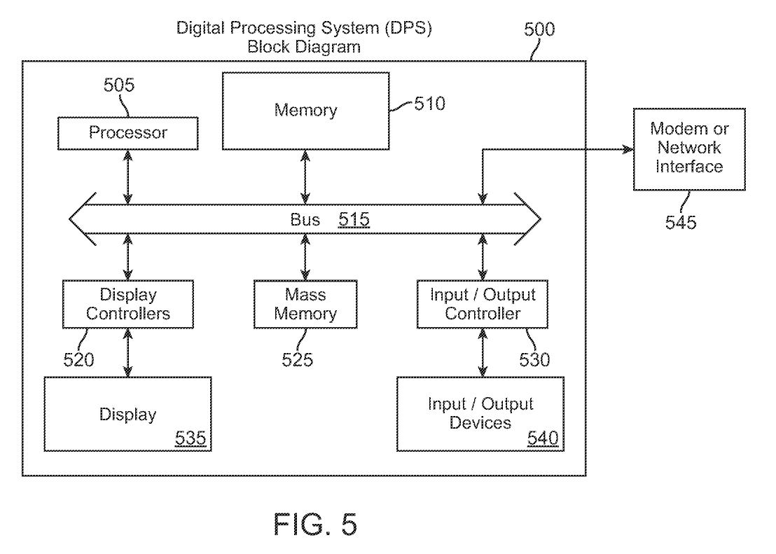

As discussed above, in some example embodiments, the PNS may employ DPSs or devices having digital processing capabilities. Such DPSs may be a processor and memory or may be part of a more complex system having additional functionality. For example, the system 500 may be used to perform one or more functions of a digital signal processing in accordance with one example embodiment. FIG. 5 illustrates a functional block diagram of a digital processing system that may be used in accordance with one embodiment. The components of processing system 500 are exemplary in which one or more components may be omitted or added. For example, one or more memory devices may be utilized for processing system 500.

In one example embodiment, the processing system 500 includes a processor 505, which may represent one or more processors and may include one or more conventional types of processors, such as Motorola PowerPC processor or Intel Pentium processor, etc. A memory 510 is coupled to the processor 505 by a bus 515. The memory 510 may be a dynamic random access memory (DRAM) and/or may include static RAM (SRAM). The processor 505 may also be coupled to other types of storage areas/memories (e.g. cache, Flash memory, disk, etc.), that could be considered as part of the memory 510 or separate from the memory 510. The bus 515 further couples the processor 505 to a display controller 520, a mass memory 525 (e.g. a hard disk or other storage which stores all or part of the DR algorithms), a network interface or modem 545, and an input/output (I/O) controller 530.

The mass memory 525 may represent a magnetic, optical, magneto-optical, tape, and/or other type of machine-readable medium/device for storing information. For example, the mass memory 525 may represent a hard disk, a read-only or writeable optical CD, etc. The display controller 520 controls, in a conventional manner, a display 535, which may represent a cathode ray tube (CRT) display, a liquid crystal display (LCD), a plasma display, or other type of display device. The I/O controller 530 controls I/O device(s) 540, which may include one or more keyboards, mouse/track ball or other pointing devices, magnetic and/or optical disk drives, printers, scanners, digital cameras, microphones, etc.

In one example embodiment, the processing system 500 may be interfaced to external systems through a network interface or modem 545. The network interface or modem may be considered a part of the processing system 500. The network interface or modem may be an analog modem, an ISDN modem, a cable modem, a token ring interface, a satellite transmission interface, a wireless interface, or other interface(s) for providing a data communication link between two or more processing systems. Further, though described for various embodiments in specific context, embodiments of the invention are applicable to a variety of single channel or multi-channel data transfer systems employing multiple data standards.

The processing system 500 represents only one example of a system, which may have many different configurations and architectures and which may be employed embodiments of the invention. For example, various manufacturers provide systems having multiple busses, such as a peripheral bus, a dedicated cache bus, etc. On the other hand, a network computer, which may be used as a processing system of the present invention, may not include, for example, a hard disk or other mass storage device, but may receive routines and/or data from a network connection, such as the network interface or modem 545, to be processed by the processor 505. Similarly, a portable communication and data processing system, which may employ a cellular telephone and/or paging capabilities, may be considered a processing system that may be used with the present invention. However, such a system may not include one or more I/O devices, such as those described above with reference to I/O device 540.

In the system 500, the mass memory 525 (and/or the memory 510) may store data that may be processed according to the methods disclosed herein. For example, the mass memory 525 may contain a database storing previously determined personal navigation and location information and PNS-related algorithms, such as Kalman Filter, Particle Filter and other algorithms disclosed herein and know to those of skill in the art. Alternatively, data may be received by the system 500, for example, via the network interface or modem 545, and stored and/or presented by the display 535 and/or the I/O device(s) 540. In one example embodiment, data may be transmitted across a communication network, such as a LAN and/or the Internet.

The operations of the PNS may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. Embodiments of the invention may be provided as a computer program product that may include a machine-readable medium having stored thereon instructions, which may be used to program a computer (or other electronic devices) to perform a process according to the invention. The machine-readable medium may include, but is not limited to, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A personal navigation and positioning system comprising:
a navigation module including
a navigation satellite receiver operable to receive satellite navigation data;
a plurality of dead reckoning sensors operable to measure dead reckoning data;
a processing device configured to
determine the mode of locomotion of the personal navigation and positioning system based on one or more of the user input, satellite navigation data and dead reckoning measurement data;
select based on the determined mode of locomotion a data processing algorithm out of a plurality of data processing algorithms; and
process the satellite navigation data and dead reckoning measurement data using the selected data processing algorithm to determine the location and orientation of the personal navigation and positioning system; and
a display operable to display the location and orientation information in a graphical form, the display being detachably joined to the navigation module as to allow free movement of the display relative to the navigation module without impairing the dead reckoning measurements.

2. The system of claim 1, wherein the locomotion modes include at least a driving mode and a walking mode.

3. The system of claim 2, wherein the display is communicatively coupled to the navigation module via one or more of a wireless interface and a wired interface.

4. The system of claim 3, wherein the dead reckoning sensors include one or more accelerometers, one or more magnetometers, one or more gyroscopes and one or more barometers.

5. The system of claim 4, wherein the satellite navigation receiver includes a Global Navigation Satellite System receive.

6. A method for personal navigation using a personal navigation device, the method comprising:
receiving satellite navigation data indicative of the location of the personal navigation device;
performing dead reckoning measurements to generate data indicative of the location of the personal navigation device;
determining the locomotion mode of the personal navigation device based on one or more of the user input, satellite navigation data and dead reckoning measurement data;
selecting based on the determined locomotion mode a data processing algorithm out of plurality of data processing algorithms;
processing the satellite navigation data and dead reckoning measurement data using the selected data processing algorithm to determine the location and orientation of the personal navigation device; and
communicating the location and orientation information to a remote display, wherein the movement of the display does not impair the dead reckoning measurements.

7. The method of claim 6, wherein the locomotion modes include at least a driving mode and a walking mode.

8. The method of claim 6, wherein communicating the location and orientation information to a remote display includes communicating via one of a wireless communication interface or wired communication interface.

9. The method of claim 6, wherein performing dead reckoning measurements includes performing measurements using one or more accelerometers, one or more magnetometers, one or more gyroscopes or one or more barometers.

10. The method of claim 6, wherein receiving satellite navigation data includes receiving Global Navigation Satellite System data.

11. A method for personal navigation using a personal navigation device, the method comprising:
receiving satellite navigation data indicative of the location of the personal navigation device;
receiving dead reckoning measurement data indicative of the location of the personal navigation device;
determining the dynamics of the motion of the personal navigation device based on one or more of the satellite navigation data and dead reckoning measurement data;
selecting based on the motion dynamics a data processing algorithm out of plurality of data processing algorithms;
processing the satellite navigation data and dead reckoning measurement data using the selected data processing algorithm to determine the location and orientation of the personal navigation device; and
communicating the location and orientation information to a remote display, wherein the movement of the display does not impair the dead reckoning measurements.

12. The method of claim 11, wherein the dynamics of the motion include high dynamics motion and low dynamics motion.

13. The method of claim 11, wherein communicating the location and orientation information to a remote display includes communicating via one of a wireless communication interface or wired communication interface.

14. The method of claim 11, wherein the dead reckoning measurements data includes one or more accelerometer measurement, magnetometer measurement, gyroscope measurement and barometer measurement.

15. The method of claim 11, wherein receiving satellite navigation data includes receiving Global Navigation Satellite System data.

16. A machine-readable medium that provides executable instructions, which when executed by a processor, cause the processor to perform a method, the method comprising:
receiving satellite navigation data indicative of the location and orientation of a personal navigation device;
receiving dead reckoning measurement data indicative of the location and orientation of the personal navigation device;
determining the locomotion mode of the personal navigation device based on one or more of the user input, satellite navigation data and dead reckoning measurement data;
selecting based on the determined locomotion mode a data processing algorithm out of plurality of data processing algorithms;
processing the satellite navigation data and dead reckoning measurement data using the selected data processing algorithm to determine the location and orientation of the personal navigation device; and
communicating the location and orientation information to a remote display, wherein the movement of the display does not impair the dead reckoning measurements.

17. The machine-readable medium of claim 16, wherein the locomotion modes include at least a driving mode and a walking mode.

18. The machine-readable medium of claim 16, wherein communicating the location and orientation information to a remote display includes communicating via one of a wireless communication interface or wired communication interface.

19. The machine-readable medium of claim 16, wherein the dead reckoning measurements data includes one or more accelerometer measurement, magnetometer measurement, gyroscope measurement and barometer measurement.

20. The machine-readable medium of claim 16, wherein receiving satellite navigation data includes receiving Global Navigation Satellite System data.
